(19) United States
(12) Patent Application Publication
(10) Pub. No.: US 2025/0112254 A1
(43) Pub. Date: Apr. 3, 2025

(54) FUEL CELL SEPARATOR AND FUEL CELL STACK

(71) Applicant: Honda Motor Co., Ltd., Tokyo (JP)

(72) Inventors: Shun Hattori, Saitama (JP); Suguru Omori, Saitama (JP); Kenta Watanabe, Saitama (JP)

(21) Appl. No.: 18/892,724

(22) Filed: Sep. 23, 2024

(30) Foreign Application Priority Data
Sep. 29, 2023 (JP) 2023-170004

(51) Int. Cl. H01M 8/04029; H01M 8/04007

(52) U.S. Cl. CPC H01M 8/04029; H01M 8/04067; H01M 2250/20

(57) ABSTRACT

A fuel cell separator including a pair of plates joined with each other to form a cooling medium flow path through which a cooling medium flows between the pair of plates. The each of the pair of plates includes a first flow path forming part forming gas flow paths in spaces between a membrane electrode assembly and outer surfaces of the separator, a seal part protruding toward a structure including the membrane electrode assembly to block a communication of communication holes provided in the separator and the gas flow paths, a tunnel part provided crossing the seal part to protrude toward the structure to form a communication flow path communicating the communication holes and the cooling medium flow path, and a second flow path forming part forming a connecting flow path continuous to the tunnel part.

### CROSS-REFERENCE TO RELATED APPLICATION

This application is based upon and claims the benefit of priority from Japanese Patent Application No. 2023-170004 filed on Sep. 29, 2023, the content of which is incorporated herein by reference.

### BACKGROUND OF THE INVENTION

### Field of the Invention

This invention relates to a fuel cell separator and a fuel cell stack.

### Description of the Related Art

In recent years, technological developments have been made on a fuel cell that contribute to energy efficiency in order to ensure access to energy that is affordable, reliable, sustainable and advanced by more people. This type of fuel cell has a structure that includes a junction of an electrolyte membrane and an electrode, and a separator, which are alternately stacked to form a fuel cell stack. As a separator to be incorporated into such a fuel cell stack, conventionally, a separator formed by joining a pair of metal plates and having a cooling medium flow path through which a cooling medium flows between the pair of metal plates, is known. Such a separator is described, for example, in Japanese Examined Patent Publication No. 7038692 (JP 7038692 B).

In the separator described in JP 7038692 B, a communication hole for a cooling medium inlet and a communication hole for a cooling medium outlet are provided on one side and the other side of the cooling medium flow path, respectively, and metal bead seals are provided around these communication holes. Furthermore, in the separator, tunnels are provided so as to cross the metal bead seals, and the cooling medium flow path and the communication holes are connected through the tunnels.

In the separator described in JP 7038692 B, the area between the central region of the cooling medium flow path and the tunnel is configured to be substantially flat by a pair of metal plates. As a result, the rigidity of the pair of metal plates is low, and the separator is prone to deflection and deformation.

### SUMMARY OF THE INVENTION

An aspect of the present invention is a fuel cell separator included in a fuel cell stack, the fuel cell stack being configured by alternately stacking the fuel cell separator and a structure including a membrane electrode assembly, the membrane electrode assembly being a joint body of an electrolyte membrane and an electrode. The fuel cell separator includes a pair of plates made of metal and joined together, the pair of plates including inner surfaces facing with each other and outer surfaces on opposite sides of the inner surfaces and being configured to form a cooling medium flow path through which a cooling medium flows between a pair of the inner surfaces. Communication holes forming a cooling medium supply flow path to supply the cooling medium to the cooling medium flow path and a cooling medium discharge flow path to discharge the cooling medium from the cooling medium flow path are provided in each of the pair of plates, the fuel cell separator includes a first area facing the membrane electrode assembly, a second area around the communication holes, and a third area between the first area and the second area, and the each of the pair of plates includes: a first flow path forming part with an uneven shape provided in the first area to form gas flow paths in spaces between the membrane electrode assembly and the outer surfaces; a seal part provided in the second area so as to protrude toward the structure to block a communication of the communication holes and the spaces; a tunnel part provided crossing the seal part so as to protrude toward the structure to form a communication flow path communicating the communication holes and the cooling medium flow path; and a second flow path forming part with an uneven shape provided in the third area so as to be continuous to the tunnel part to form a connecting flow path included in the cooling medium flow path.

Another aspect of the present invention is a fuel cell stack including: a plurality of structures each including a membrane electrode assembly, the membrane electrode assembly being a joint body of an electrolyte membrane and an electrode; and a plurality of separators alternately stacking with the plurality of structures, each of the plurality of separators being the above separator.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a cross-sectional view along line II-II in FIG. 1;

FIG. 3 is a perspective view showing a schematic configuration of a unitized electrode assembly included in the fuel cell stack of FIG. 1;

FIG. 4A is a rear view of a fuel cell separator according to the embodiment of the present invention;

FIG. 4B is a front view of the fuel cell separator according to the embodiment of the present invention;

FIG. 5 is a cross-sectional view of a main part of the separator in FIGS. 4A and 4B;

FIG. 6A is a cross-sectional view along line A-A in FIG. 4A;

FIG. 6B is a cross-sectional view along line B-B in FIG. 4B;

FIG. 7 is an enlarged view of part VII of FIG. 4A;

FIG. 8 is a cross-sectional view along line VIII-VIII in FIG. 7;

FIG. 9 is a cross-sectional view along line IX-IX in FIG. 7;

FIG. 10 is a diagram showing a modification of FIG. 7; and

FIG. 11 is a diagram showing another modification of FIG. 7.

### DETAILED DESCRIPTION OF THE INVENTION

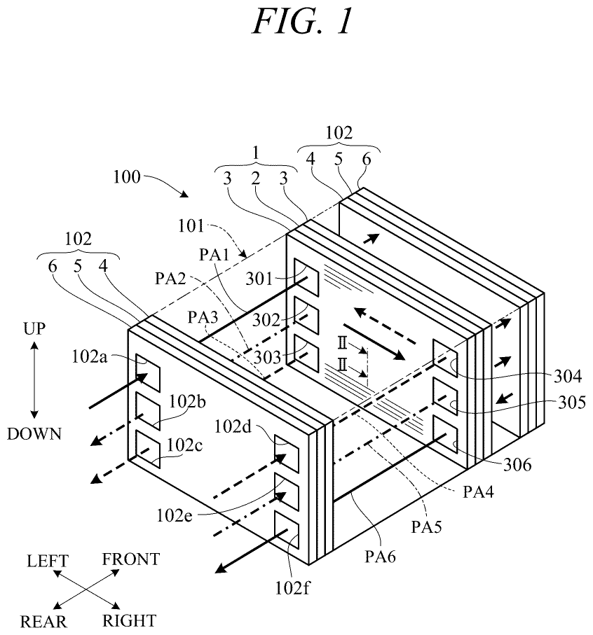

Hereinafter, an embodiment of the present invention will be described with reference to FIGS. 1 to 11. A fuel cell stack according to an embodiment of the present invention is a main component of a fuel cell and included in the fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. These directions may be different from a front-rear direction, a left-right direction, and an up-down direction of the vehicle. For example, the front-rear direction of FIG. 1 may be the front-rear direction, the left-right direction, or the up-down direction of the vehicle.

As shown in FIG. 1, the fuel cell stack 100 has a cell stacked body 101 formed by stacking a plurality of power generation cells 1 in the front-rear direction, and end units 102 arranged at both front and rear ends of the cell stacked body 101, and the whole of the fuel cell stack 100 has a substantially rectangular parallelepiped shape. The length of the cell stacked body 101 in the left-right direction is longer than its length in the up-down direction. For convenience, a single power generation cell 1 is shown in FIG. 1. The power generation cell 1 has a unitized electrode assembly 2 including a membrane electrode assembly that includes an electrolyte membrane and electrodes, and separators 3 and 3 arranged on both front and rear sides of the unitized electrode assembly 2. The unitized electrode assembly 2 and the separator 3 are alternately arranged in the front-rear direction.

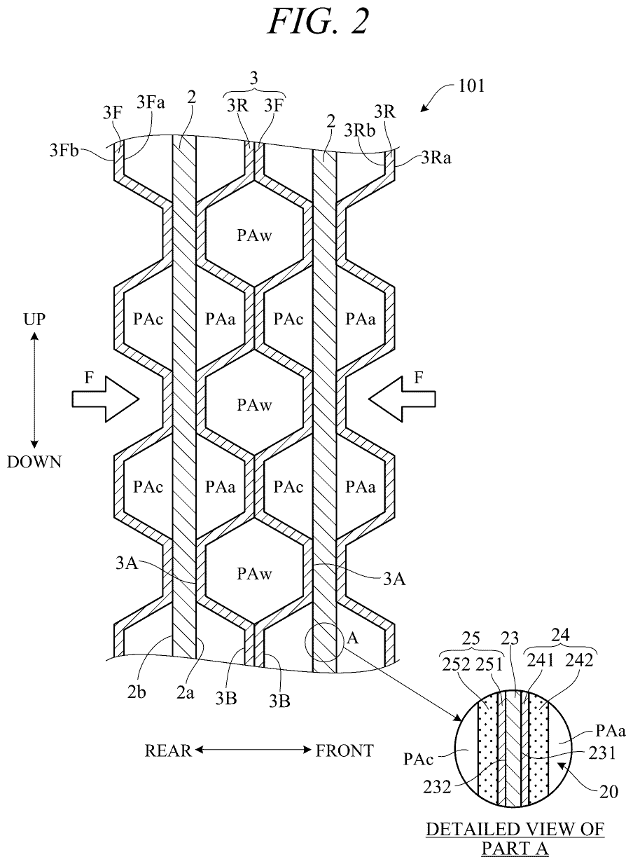

FIG. 2 is a cross-sectional view (along line II-II in FIG. 1) of the central part in the left-right direction of the cell stacked body 101. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling medium flows is formed. The generating surface of the power generation cell 1 is cooled by the flow of the cooling medium. Water, for example, can be used as the cooling medium. The separator is configured with an even shape by press molding or the like to form a gas flow path between the surface of the separator 3 facing the unitized electrode assembly 2 (front surface 3Fa and rear surface 3Rb) and the unitized electrode assembly 2. More specifically, the separator 3 has a pair of front and rear rib portions 3A and 3A protruding towards the unitized electrode assembly 2, and a pair of front and rear concave portions 3B and 3B, which are concavely formed in continuation to the pair of front and rear rib portions 3A and 3A. The pair of front and rear concave portions 3B and 3B contact each other.

The pair of front and rear rib portions 3A and 3A contact the front surface 2a and the rear surface 2b of the unitized electrode assembly 2. In the cell stacked body 101, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the unitized electrode assembly 2 through the rib portion 3A.

Between the front surface 2a of the unitized electrode assembly 2 and the rear plate 3R of the separator 3 facing this front surface 2a, an anode flow path PAa through which fuel gas flows is formed by the concave portion 3B. Between the rear surface 2b of the unitized electrode assembly 2 and the front plate 3F of the separator 3 facing this rear surface 2b, a cathode flow path PAc through which oxidant gas flows is formed by the concave portion 3B. For example, hydrogen gas can be used as the fuel gas, and air can be used as the oxidant gas. The fuel gas and the oxidant gas may be referred to as a reaction gas without being distinguished from each other.

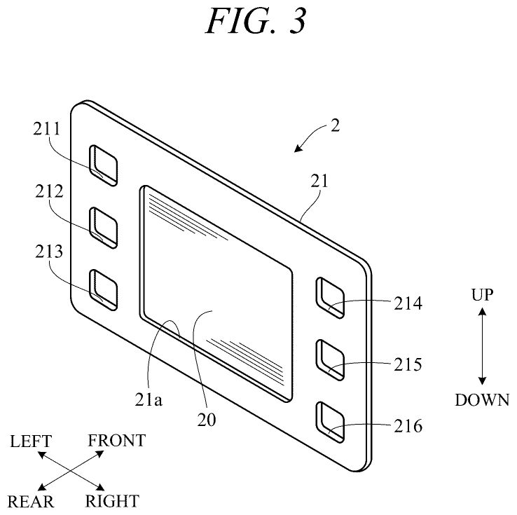

FIG. 3 is a perspective view showing a schematic configuration of the unitized electrode assembly 2. As shown in FIG. 3, the unitized electrode assembly 2 includes a substantially rectangular membrane electrode assembly 20 and a frame 21 that supports the membrane electrode assembly 20. As shown in the detailed view of part “A” in FIG. 1, the membrane electrode assembly 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 231 of the electrolyte membrane 23 and served as a reaction field for electrode reaction, and a gas diffusion layer 242 formed on the front surface of the electrode catalyst layer 241 to spread and supply the fuel gas. An intermediate layer (underlayer) can also be provided between the electrode catalyst layer 241 and the gas diffusion layer 242. The cathode electrode 25 has an electrode catalyst layer 251 formed on the rear surface 232 of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 251 and the gas diffusion layer 252.

The electrode catalyst layers 241 and 251 include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 242 and 252 are made of conductive members with gas permeability, such as carbon porous bodies. The gas diffusion layers 242 and 252 have a water-repellent function because they are mainly composed of carbon and fluorine.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the unitized electrode assembly 2 along the gas flow.

The frame 21 in FIG. 3 is a thin plate having a substantially rectangular shape, and is made of an insulating resin, rubber, or the like. A substantially rectangular opening 21a is provided in a central portion of the frame 21. The membrane electrode assembly 20 is disposed to cover the entire opening 21a and a peripheral portion of the membrane electrode assembly 20 is supported by the frame 21. Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21.

As shown in FIG. 1, in the separator 3 in front of and behind the unitized electrode assembly 2, through-holes 301 to 306 penetrating the separators 3 in the front-rear direction are opened at positions corresponding to the through-holes 211 to 216 of the frame 21. The through-holes 301 to 306 communicate with the through-holes 211 to 216 of the frame 21, respectively. The set of the through-holes 211 to 216 and 301 to 306 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

The flow path PA1 (solid arrow) extending forward via the through-holes 211 and 301 is a fuel gas supply flow path. The flow path PA6 (solid arrow) extending rearward via the through-holes 216 and 306 is a fuel gas discharge flow path. The fuel gas supply flow path PA1 and the fuel gas discharge flow path PA6 communicate with the anode flow path PAa (FIG. 2) facing the front surface of the membrane electrode assembly 20, and as indicated by the solid arrows, the fuel gas flows through the anode flow path in the left-right direction via the fuel gas supply flow path PA1 and the fuel gas discharge flow path PA6. The communication between the anode flow path PAa and the other flow paths PA2 to PA5 is blocked via bead portions described later.

The flow path PA4 (dotted arrow) extending forward via the through-holes 214 and 304 is an oxidant gas supply flow path. The flow path PA3 (dotted arrow) extending rearward via the through-holes 213 and 303 is an oxidant gas discharge flow path. The oxidant gas supply flow path PA4 and the oxidant gas discharge flow path PA3 communicate with the cathode flow path Pac (FIG. 2) facing the rear surface of the membrane electrode assembly 20, and as indicated by the dotted arrows, the oxidant gas flows through the cathode flow path PAc in the left-right direction via the oxidant gas supply flow path PA4 and the oxidant gas discharge flow path PA3. The communication between the cathode flow path PAc and the other flow paths PA1, PA2, PA5 and PA6 is blocked via bead portions described later.

The flow path PA5 (dashed-dotted arrow) extending forward via the through-holes 215 and 305 is a cooling medium supply flow path. The flow path PA2 (dashed-dotted arrow) extending rearward via the through-holes 212 and 312 is a cooling medium discharge flow path. The cooling medium supply flow path PA5 and the cooling medium discharge flow path PA2 communicate with the cooling flow path PAw (FIG. 2) inside the separator 3, and the cooling medium flows through the cooling flow path PAw via the cooling medium supply flow path PA5 and the cooling medium discharge flow path PA2. The communication between the cooling flow path PAw and the other flow paths PA1, PA3, PA4 and PA6 is blocked via bead portions described later.

As shown in FIG. 2, each of the end units 102 disposed on both the front and rear sides of the cell stacked body 101 includes a terminal plate 4, an insulating plate 5, and an end plate 6. The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6.

The end plate 6 is a plate-shaped member made of metal or resin having high strength. A connecting member having elongated shape in the front-rear direction, for example, are fixed to a pair of end plates 6 and 6 by bolts, and the pair of end plates 6 and 6 are connected to each other through the connecting member. The fuel cell stack 100 is held in a state where it is pressed in the front-rear direction by the end plates 6 and 6 through the connecting member. This applies a compressive load F (FIG. 2) in the front-rear direction to the unitized electrode assembly 2 and the separator 3. A case surrounding the cell stacked body 101 may be used as a connecting member, and the front and rear end plates 6 and 6 may be fixed to the front and rear end surfaces of the case, respectively.

A plurality of through-holes 102a to 102f that penetrate the end unit 102 in the front-rear direction are opened in the rear end unit 102. The through-hole 102a is opened on the extension line of the fuel gas supply flow path PA1 so as to communicate with the fuel gas supply flow path PA1. The through-hole 102b is opened on the extension line of the cooling medium discharge flow path PA2 so as to communicate with the cooling medium discharge flow path PA2. The through-hole 102c is opened on the extension line of the oxidant gas discharge flow path PA3 so as to communicate with the oxidant gas discharge flow path PA3. The through-hole 102d is opened on the extension line of the oxidant gas supply flow path PA4 so as to communicate with the oxidant gas supply flow path PA4. The through-hole 102e is opened on the extension line of the cooling medium supply flow path PA5 so as to communicate with the cooling medium supply flow path PA5. The through-hole 102f is opened on the extension line of the fuel gas discharge flow path PA6 so as to communicate with the fuel gas discharge flow path PA6.

More specifically, a fuel gas tank storing high-pressure fuel gas is connected to the through-hole 102a via an ejector, an injector, etc., and the fuel gas is supplied to the fuel cell stack 100 through the through-hole 102a. The fuel gas is discharged from the through-hole 102f. A compressor for supplying oxidant gas is connected to the through-hole 102d, and the oxidant gas compressed by the compressor is supplied to the fuel cell stack 100 through the through-hole 102d. The oxidant gas is discharged from the through-hole 102c. A pump for supplying cooling medium is connected to the through-hole 102e, and the cooling medium is supplied to the fuel cell stack 100 through the through-hole 102e. The cooling medium is discharged from the through-hole 102b. The discharged cooling medium is cooled by heat exchange in the radiator, and is supplied again to the fuel cell stack 100 through the through-hole 102e.

The above is the schematic configuration of the fuel cell stack 100. The fuel cell stack 100 is housed in a substantially box-shaped case and mounted on a vehicle. The fuel cell stack 100 according to the present embodiment is characterized by the configuration of the separator 3 incorporated in the fuel cell stack 100. Below, the configuration of the separator 3 is explained in more detail.

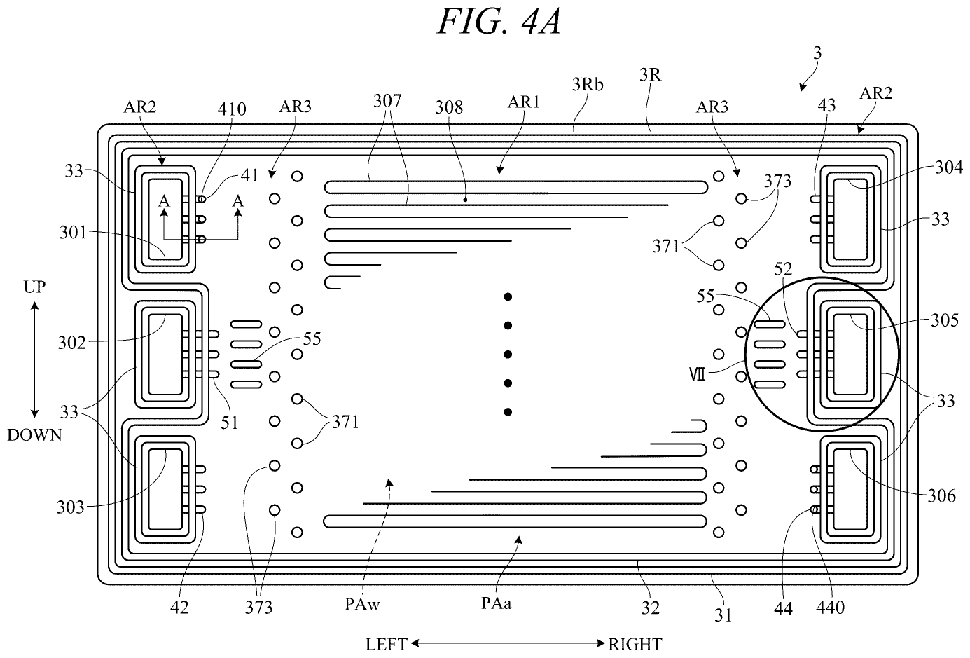

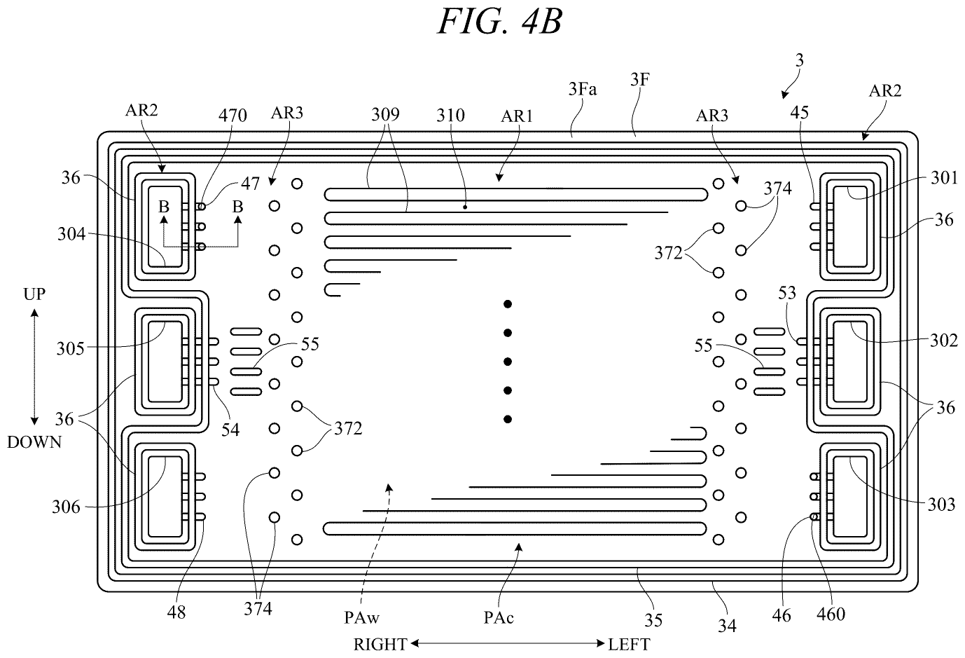

FIG. 4A is a rear view of the separator 3 (view from the rear), and FIG. 4B is a front view of the separator 3 (view from the front). In other words, FIG. 4A shows the rear surface 3Rb (FIG. 2) of the rear plate 3R facing the anode electrode 24 on the front surface 2a of the unitized electrode assembly 2, and FIG. 4B shows the front surface 3Fa (FIG. 2) of the front plate 3F facing the cathode electrode 25 on the rear surface 2b of the unitized electrode assembly 2. Both FIG. 4A and FIG. 4B are front views of the separator 3.

Hereinafter, in the front view of the separator 3, the area facing the membrane electrode assembly 20 (FIG. 3) of the unitized electrode assembly 2, that is, the area AR1 facing the power generation surface, is referred to as an active area of the separator 3 for convenience, and areas other than the active area are referred to as inactive areas. Since the active area AR1 is located in the central part of the separator 3 in the left-right direction, the active area AR1 may also be referred to as a central area of the separator 3.

Among the inactive areas, the area at the left-right ends where the through-holes 301 to 306 are provided is referred to as an end area AR2 of the separator 3 for convenience. The end area AR2 includes the flow paths PA1 to PA6 for supply and discharge of reaction gas and cooling medium. Among the inactive areas, the area inside in the left-right direction of the end area AR2 is referred to as a connection area AR3 of the separator 3 for convenience. The connection areas AR3 are located between the active area AR1 and the left and right end areas AR2.

As shown in FIG. 4A, in the active area AR1 of the rear plate 3R, although some illustrations are omitted, multiple convex portions 307 are provided so as to protrude rearward at equal intervals in the up-down direction in almost the entire area of the active area AR1. The convex portions 307 extend in the left-right direction, and a concave portion 308 (corresponding to the concave portion 3B in FIG. 2) is provided between the convex portions 307 and 307 adjacent in the up-down direction. The anode flow paths PAa (FIG. 2) are formed between the multiple concave portions 308 and the front surface of the membrane electrode assembly 20. On the rear surface 3Rb of the rear plate 3R, multiple embossed portions 371 are provided at equal intervals in the up-down direction on both the right and left sides of the convex portions 307. More specifically, a plurality of substantially cylindrical embossed portions 371 are protruded rearward from the rear surface 3Rb of the rear plate 3R in the inlet and outlet areas of the anode flow path PAa. FIG. 4A shows a single row of embossed portions 371 in the up-down direction, but multiple rows of embossed portions 371 may be provided. The embossed portion 371 may be omitted.

As shown in FIG. 4B, in the active area AR1 of the front plate 3F, although some illustrations are omitted, multiple convex portions 309 are provided so as to protrude forward at equal intervals in the up-down direction in almost the entire area of the active area AR1. The convex portions 309 extend in the left-right direction, and a concave portion 310 (corresponding to the concave portion 3B in FIG. 2) is provided between the convex portions 309 and 309 adjacent in the up-down direction. The cathode flow paths PAc (FIG. 2) are formed between the multiple concave portions 310 and the rear surface of the membrane electrode assembly 20. On the front surface 3Fa of the front plate 3F, multiple embossed portions 372 are provided at equal intervals in the up-down direction on both the right and left sides of the convex portions 309. More specifically, a plurality of substantially cylindrical embossed portions 372 are protruded forward from the front surface 3Fa of the front plate 3F in the inlet and outlet areas of the cathode flow path PAc. FIG. 4B shows a single row of embossed portions 372 in the up-down direction, but multiple rows of embossed portions 372 may be provided. The embossed portion 372 may be omitted.

As shown in FIG. 4A, on the rear surface 3Rb of the rear plate 3R, multiple bead portions for sealing, namely, metal bead seals are provided so as to protrude rearward towards the frame 21. The bead portions include an outer bead portion 31, an inner bead portion 32, and an end bead portion 33, which are formed by pressing the rear plate 3R.

In a front view of the separator 3, the outer bead portion 31 extends along the periphery of the rear plate 3R so as to surround the entirety of through-holes 301 to 306, and the whole has a substantially rectangular shape. The end bead portion 33 is provided for each of the through-holes 301 to 306. Each of the multiple end bead portions 33 has a substantially rectangular shape corresponding to the shape of each of the through-holes 301 to 306 and individually surrounds each of the multiple through-holes 301 to 306. The inner bead portion 32 is provided inside the outer bead portion 31. More specifically, the inner bead portion 32 extends in a zigzag manner via the outer sides in the left-right direction of the end bead portions 33 around the through-holes 301, 303, 304 and 306 and via the inner sides in the left-right direction of the end bead portions 33 around the through-holes 302 and 305. The end bead portions 33 around the through-holes 302 and 305 are located between the outer bead portion 31 and the inner bead portion 32.

As shown in FIG. 4B, the front surface 3Fa of the front plate 3F, multiple bead portions for sealing are provided so as to protrude forward towards the frame 21. The bead portions include an outer bead portion 34, an inner bead portion 35, and an end bead portion 36, which are formed by pressing the front plate 3F.

In a front view of the separator 3, the outer bead portion 34 extends along the periphery of the front plate 3F so as to surround the entirety of through-holes 301 to 306, and the whole has a substantially rectangular shape. The end bead portion 36 is provided for each of the through-holes 301 to 306. Each of the multiple end bead portions 36 has a substantially rectangular shape corresponding to the shape of each of the through-holes 301 to 306 and individually surrounds each of the multiple through-holes 301 to 306. The inner bead portion 35 is provided inside the outer bead portion 34. More specifically, the inner bead portion 35 extends in a zigzag manner via the outer sides in the left-right direction of the end bead portions 36 around the through-holes 301, 303, 304 and 306 and via the inner sides in the left-right direction of the end bead portions 36 around the through-holes 302 and 305. The end bead portions 36 around the through-holes 302 and 305 are located between the outer bead portion 34 and the inner bead portion 35.

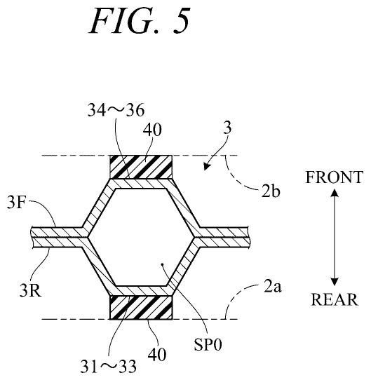

FIG. 5 is a cross-sectional view of a main part of the separator 3, with the bead portions 31 to 36 cut vertically. As shown in FIG. 5, the bead portions 31 to 36 have a substantially rectangular cross-section, more specifically, a substantially trapezoidal cross-section. The multiple bead portions 31 to 33 of the rear plate 3R and the multiple bead portions 34 to 36 of the front plate 3F are provided in the same position relative to each other in a front view, that is, in the up-down and left-right directions. Therefore, a substantially rectangular space SPO is provided between the bead portions 31 to 33 and the bead portions 34 to 36.

A sealing material 40 is affixed to the rear surface of the bead portions 31 to 33 and the front surface of the bead portions 34 to 36. The sealing material 40 is made of a component material having elasticity, such as rubber or resin. The front sealing material 40 is pressed against the rear surface 2b of the frame 21 (FIG. 3) of the unitized electrode assembly 2, and the rear sealing material 40 is pressed against the front surface 2a of the frame 21. This seals the gaps between bead portions 31 to 36 and the frame 21, allowing for the formation of sealed anode flow path PAa and cathode flow path PAc between the unitized electrode assembly 2 and the separator 3. It is also possible to omit the sealing material 40 and directly contact the tip of bead portions 31 to 36 with the frame 21.

The anode flow path PAa and the cathode flow path PAc are provided inside the inner bead portions 32 and 35 as viewed from the front of the separator 3. Inside the inner bead portions 32 and 35, multiple through-holes 301, 303, 304 and 306 are arranged. However, the communications between the anode flow path PAa and the through-holes 301, 303, 304 and 306 are blocked by the end bead portion 33, and the communications between the cathode flow path PAc and the through-holes 301, 303, 304 and 306 are blocked by the end bead portion 36. In the present embodiment, several tunnel portions that intersect perpendicularly (cross) with the end bead portion 33 are provided in the separator 3 so that the anode flow path PAa communicates with the through-holes 301 and 306 and the cathode flow path PAc communicates with the through-holes 303 and 304, respectively.

More specifically, as shown in FIG. 4A, in the end bead portion 33 around the through-hole 301 of the rear plate 3R, several (for example, three) tunnel portions 41 are provided parallel to each other and at equal intervals in the up-down direction, intersecting the right end bead portion 33 extending in the up-down direction in the left-right direction. In the end bead portion 33 around the through-hole 303, several (for example, three) tunnel portions 42 are provided parallel to each other and at equal intervals in the up-down direction, intersecting the right end bead portion 33 extending in the up-down direction in the left-right direction. In the end bead portion 33 around the through-hole 304, several (for example, three) tunnel portions 43 are provided parallel to each other and at equal intervals in the up-down direction, intersecting the left end bead portion 33 extending in the up-down direction in the left-right direction. In the end bead portion 33 around the through-hole 306, several (for example, three) tunnel portions 44 are provided parallel to each other and at equal intervals in the up-down direction, intersecting the left end bead portion 33 extending in the up-down direction in the left-right direction.

Similarly, as shown in FIG. 4B, in the end bead portion 36 around the through-hole 301 of the front plate 3F, several (for example, three) tunnel portions 45 are provided parallel to each other and at equal intervals in the up-down direction, intersecting the right end bead portion 36 extending in the up-down direction in the left-right direction. In the end bead portion 36 around the through-hole 303, several (for example, three) tunnel portions 46 are provided parallel to each other and at equal intervals in the up-down direction, intersecting the right end bead portion 36 extending in the up-down direction in the left-right direction. In the end bead portion 36 around the through-hole 304, several (for example, three) tunnel portions 47 are provided parallel to each other and at equal intervals in the up-down direction, intersecting the left end bead portion 36 extending in the up-down direction in the left-right direction. In the end bead portion 36 around the through-hole 306, several (for example, three) tunnel portions 48 are provided parallel to each other and at equal intervals in the up-down direction, intersecting the left end bead portion 36 extending in the up-down direction in the left-right direction.

The number of the tunnel portions 41 to 48 described above is just an example, and each of the tunnel portions 41 to 48 can be more or less than three. The tunnel portions 41 to 44 of the rear plate 3R and the tunnel portions 45 to 48 of the front plate 3F are provided at the same positions when viewed from the front of the separator 3. The tunnel portions 41 to 48 each extends along a substantially straight line in the left-right direction, and their protrusion amounts in the front-rear direction, widths in the up-down direction, and lengths in the left-right direction are equal to each other. The tunnel portions 41 to 48 are formed by press molding the front plate 3F and the rear plate 3R.

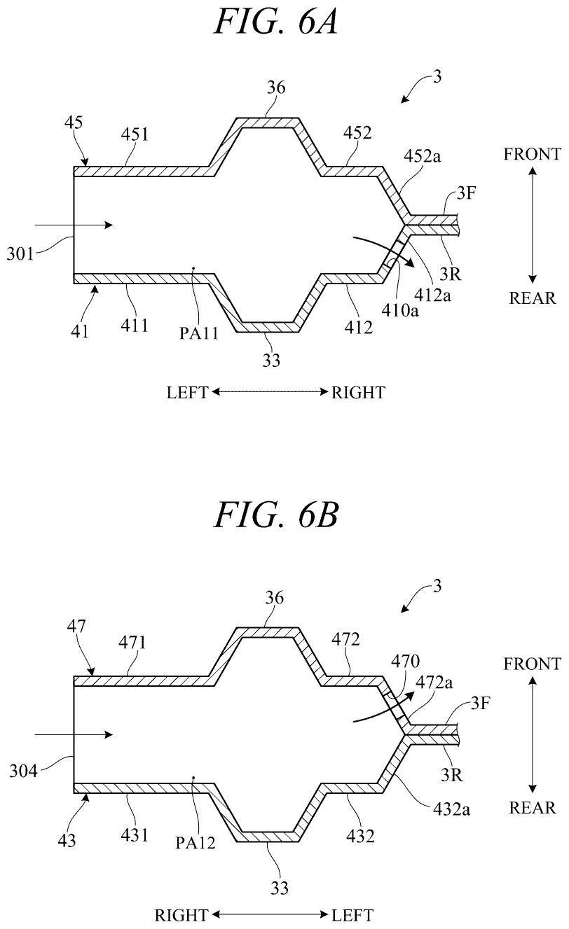

FIG. 6A is a cross-sectional view showing the configuration of the tunnel portions 41 and 45 near the through-hole 301 (a cross-sectional view along line A-A of FIG. 4A). As shown in FIG. 6A, the tunnel portion 45 of the front plate 3F is provided convexly forward, and the tunnel portion 41 of the rear plate 3R is provided convexly rearward. The protrusion amounts in the front-rear direction of the tunnel portions 41 and 45 are smaller than the protrusion amounts of the bead portions 33 and 36. Although not shown, the tunnel portions 41 and 45 have a substantially rectangular or trapezoidal cross-section, and a communication flow path PA11 is formed between the front and rear tunnel portions 41 and 45.

Among the tunnel portions 41 and 45, the left side (through-hole 301 side) of the bead portions 33 and 36 is called outer tunnel portions 411 and 451, and the right side (anode flow path PAa side) of the bead portions 33 and 36 is called inner tunnel portions 412 and 452. The left ends of the outer tunnel portions 411 and 451 are located at the periphery of the through-hole 301, and the left end of the communication flow path PA11 is opened facing the through-hole 301. The right ends of the outer tunnel portions 411 and 451 penetrate the bead portions 33 and 36 and communicate with an internal space between the bead portions 33 and 36.

The left ends of the inner tunnel portions 412 and 452 penetrate the bead portions 33 and 36 and communicate with the internal space between the bead portions 33 and 36. At the right ends of the inner tunnel portions 412 and 452, taper portions 412a and 452a are provided so that the protrusion amounts gradually decrease towards the right. At the right ends of the tunnel portions 41 and 45, the protrusion amounts in the front-rear direction become 0, and the communication flow path PA11 is closed. In the taper portion 412a of the tunnel portion 41, an outlet 410 for fuel gas is opened. Thus, the through-hole 301 and the anode flow path PAa at the rear of the rear plate 3R communicate via the communication flow path PA11 and the outlet 410. Therefore, the fuel gas flowing through the through-hole 301 can be supplied to the anode flow path PAa via the communication flow path PA11 and the outlet 410, as indicated by the arrow in FIG. 6A.

Although not shown, the tunnel portions 44 and 48 near the through-hole 306 are configured similarly to the tunnel portions 41 and 45 in FIG. 6A. That is, the tunnel portions 41 and 45 and the tunnel portions 44 and 48 have a symmetrical shape with respect to an axial line extending in the up-down direction. Therefore, an inlet 440 for fuel gas is opened in the taper portion at the left end of the tunnel portion 44 (FIG. 4A). Thus, the fuel gas flowing through the anode flow path PAa is guided to the through-hole 306 via the inlet 440 and the communication flow path PA11 between the tunnel portions 44 and 48.

FIG. 6B is a cross-sectional view showing the configuration of the tunnel portions 43 and 47 near the through-hole 304 (a cross-sectional view along line B-B of FIG. 4B). As shown in FIG. 6B, the tunnel portion 47 of the front plate 3F is provided convexly forward, and the tunnel portion 43 of the rear plate 3R is provided convexly rearward. The protrusion amount in the front-rear direction of the tunnel portions 43 and 47 are smaller than the protrusion amounts of the bead portions 33 and 36. Although not shown, the tunnel portions 43 and 47 have a substantially rectangular or trapezoidal cross-section, and a communication flow path PA12 is formed between the front and rear tunnel portions 43 and 47.

Among the tunnel portions 43 and 47, the right side (through-hole 304 side) of the bead portions 33 and 36 is called outer tunnel portions 431 and 471, and the left side (cathode flow path PAc side) of the bead portions 33 and 36 is called inner tunnel portions 432 and 472. The right ends of the outer tunnel portions 431 and 471 are located at the periphery of the through-hole 304, and the right end of the communication flow path PA12 is opened facing the through-hole 304. The left ends of the outer tunnel portions 431 and 471 penetrate the bead portions 33 and 36 and communicate with the internal space between the bead portions 33 and 36.

The right ends of the inner tunnel portions 432 and 472 penetrate the bead portions 33 and 36 and communicate with the internal space between the bead portions 33 and 36. At the left ends of the inner tunnel portions 432 and 472, taper portions 432a and 472a are provided so that the protrusion amounts gradually decrease towards the left. At the left ends of the tunnel portions 43 and 47, the protrusion amounts in the front-rear direction become 0, and the communication flow path PA12 is closed. In the taper portion 472a of the tunnel portion 47, an outlet 470 for oxidizing gas is opened. Thus, the through-hole 304 and the cathode flow path PAc in front of the front plate 3F communicate via the communication flow path PA12 and the outlet 470. Therefore, the oxidant gas flowing through the through-hole 304 can be supplied to the cathode flow path PAc via the communication flow path PA12 and the outlet 470, as indicated by the arrow in FIG. 6B.

Although not shown, the tunnel portions 42 and 46 near the through-hole 303 are configured similarly to the tunnel portions 43 and 47 in FIG. 6B. That is, the tunnel portions 43 and 47 and the tunnel portions 42 and 46 have a symmetrical shape with respect to an axial line extending in the up-down direction. Therefore, an inlet 460 for oxidant gas is opened in the taper portion at the right end of the tunnel portion 46 (FIG. 4B). Thus, the oxidant gas flowing through the cathode flow path PAc is guided to the through-hole 303 via the inlet 460 and the communication flow path PA12 between the tunnel portions 42 and 46.

As shown in FIGS. 4A and 4B, on the front plate 3F and the rear plate 3R, multiple tunnel portions 51 to 54 are provided near the through-holes 302 and 305, intersecting the bead portions 32, 33, 35 and 36. More specifically, as shown in FIG. 4A, on the rear plate 3R, to the right of the through-hole 302, multiple (for example, three) tunnel portions 51 are provided parallel to each other and at equal intervals in the up-down direction, intersecting (perpendicular to) the right end bead portion 33 extending in the up-down direction and the inner bead portion 32 extending in the up-down direction. Similarly, to the left of the through-hole 305, multiple (for example, three) tunnel portions 52 are provided parallel to each other and at equal intervals in the up-down direction, intersecting (perpendicular to) the left end bead portion 33 extending in the up-down direction and the inner bead portion 32 extending in the up-down direction.

Similarly, as shown in FIG. 4B, on the front plate 3F, to the right of the through-hole 302, multiple (for example, three) tunnel portions 53 are provided parallel to each other and at equal intervals in the up-down direction, intersecting (perpendicular to) the right end bead portion 36 extending in the up-down direction and the inner bead portion 35 extending in the up-down direction. Also, to the left of the through-hole 305, multiple (for example, three) tunnel portions 54 are provided parallel to each other and at equal intervals in the up-down direction, intersecting (perpendicular to) the left end bead portion 36 extending in the up-down direction and the inner bead portion 35 extending in the up-down direction.

The number of the tunnel portions 51 to 54 described above is just an example, and each of the tunnel portions 51 to 54 can be more or less than three. The tunnel portions 51 and 52 of the rear plate 3R and the tunnel portions 53 and 54 of the front plate 3F are provided at the same positions when viewed from the front of the separator 3. The tunnel portions 51 to 54 each extends linearly in the left-right direction, and their protrusion amounts in the front-rear direction, widths in the up-down direction, and lengths in the left-right direction are equal to each other.

As shown in FIGS. 4A and 4B, on the front plate 3F and the rear plate 3R, several substantially cylindrical embossed portions 373 and 374 are provided at equal intervals in the up-down direction on the outside of the embossed portions 371 and 372 in the left-right direction. The protruding direction of the embossed portions 373 and 374 is opposite to the protruding direction of the embossed portions 371 and 372. That is, the embossed portion 373 protrudes forward (towards the cooling flow path) from the front surface 3Ra of the rear plate 3R, and the embossed portion 374 protrudes rearward (towards the cooling flow path) from the rear surface 3Fb of the front plate 3F.

The embossed portions 373 and 374 may be positioned inside the embossed portions 371 and 372 in the left-right direction. FIGS. 4A and 4B show a single row of embossed portions 373 and 374 in the up-down direction, but multiple rows of embossed portions 373 and 374 may be provided. In this case, the embossed portions 371 and 372 and the embossed portions 373 and 374 may be alternately arranged in the left-right direction. The embossed portions 373 and 374 may be omitted.

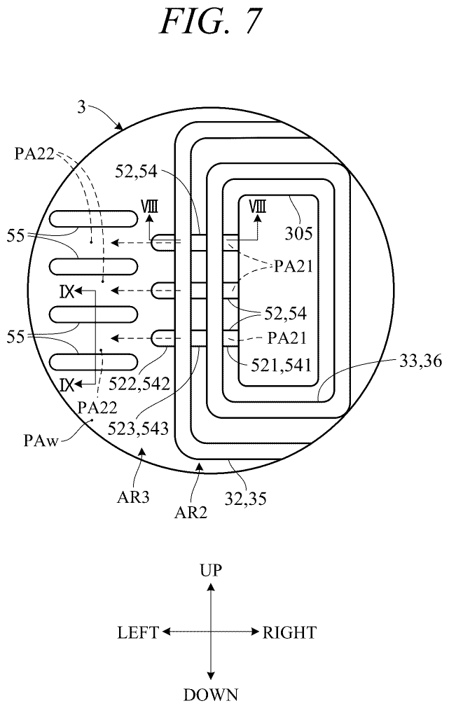

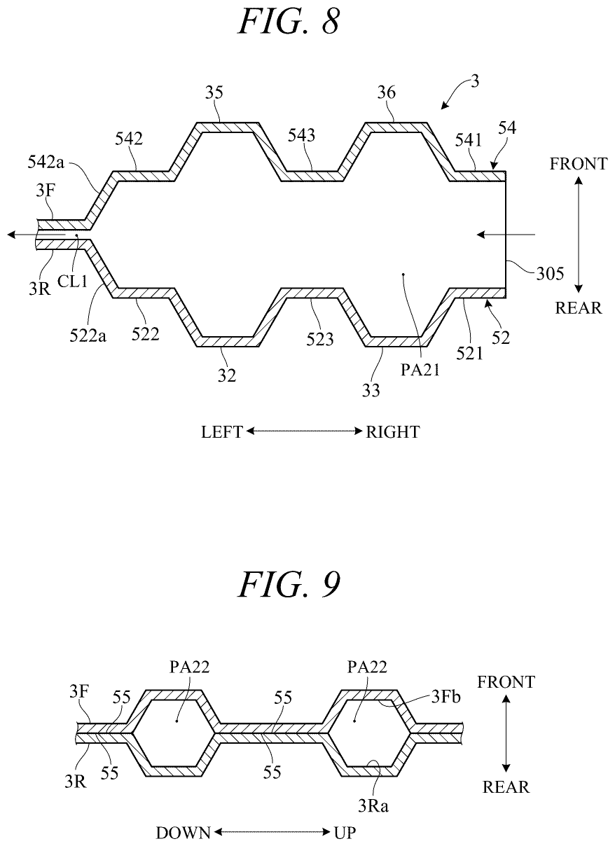

FIG. 7 is an enlarged view of a main part of FIG. 4A including the tunnel portion 52 (enlarged view of part VII), and FIG. 8 is a cross-sectional view along line VIII-VIII of FIG. 7. For convenience, FIG. 7 also shows the reference numerals for the parts of the front plate 3F corresponding to the parts of the rear plate 3R (such as the tunnel portion 54 corresponding to the tunnel portion 52). As shown in FIG. 8, the tunnel portion 54 of the front plate 3F is provided in a convex shape facing forward, and the tunnel portion 52 of the rear plate 3R is provided in a convex shape facing rearward. The protrusion amounts in the front-rear direction of the tunnel portions 52 and 54 are smaller than the protrusion amounts of the end bead portions 33 and 36 and the inner bead portions 32 and 35. Although not shown, the tunnel portions 52 and 54 have a substantially rectangular or trapezoidal cross-section, and a communication flow path PA21 is formed between the front and rear tunnel portions 52 and 54.

Among the tunnel portions 52 and 54, the right side (through-hole 305 side) of the end bead portions 33 and 36 is called outer tunnel portions 521 and 541, and the left side (cooling flow path Paw side) of the inner bead portions 32 and 35 is called inner tunnel portions 522 and 542. Among the tunnel portions 52 and 54, the area between the end bead portions 33 and 36 and the inner bead portions 32 and 35 is called intermediate tunnel portions 523 and 543. The right ends of the outer tunnel portions 521 and 541 are located at the periphery of the through-hole 305, and the right end of the communication flow path PA21 is opened facing the through-hole 305. The left ends of the outer tunnel portions 521 and 541 penetrate the end bead portions 33 and 36 and communicate with an internal space between the end bead portions 33 and 36.

The right ends of the intermediate tunnel portions 523 and 543 penetrate the end bead portions 33 and 36 and communicate with the internal space between the end bead portions 33 and 36. The left ends of the intermediate tunnel portions 523 and 543 penetrate the inner bead portions 32 and 35 and communicate with an internal space between the inner bead portions 32 and 35. The right ends of the inner tunnel portions 522 and 542 penetrate the inner bead portions 32 and 35 and communicate with the internal space between the inner bead portions 32 and 35. At the left ends of the inner tunnel portions 522 and 542, tapered portions 522a and 542a are provided so that the protrusion amounts gradually decrease towards the left. The left ends of the inner tunnel portions 522 and 542 are spaced apart from each other with a predetermined clearance CL1 in the front-rear direction, and in that state, the front plate 3F and the rear plate 3R extend to the left.

Thus, the through-hole 305 and the cooling flow path PAw on the left side of the tunnel portions 52 and 54 are communicated via the communication flow path PA21 and the clearance CL1. Therefore, the cooling medium flowing through the through-hole 305 can be supplied to the cooling flow path PAw via the communication flow path PA21 and the clearance CL1, as indicated by the arrows in FIG. 8. As shown in FIG. 7, the tunnel portions 52 and 54 are provided so that the outer tunnel portions 521 and 541, the intermediate tunnel portions 523 and 543, and the inner tunnel portions 522 and 542 are aligned and arranged on a straight line extending in the left-right direction. This reduces the pressure loss in the communication flow path PA21, allowing the cooling medium flowing through the through-hole 305 to be smoothly guided to the cooling flow path PAw.

Although not shown, the tunnel portions 51 and 53 near the through-hole 302 are configured similarly to the tunnel portions 52 and 54 in FIG. 8. That is, the tunnel portions 51 and 53 and the tunnel portions 52 and 54 have a symmetrical shape with respect to an axial line extending in the up-down direction through the central portion of the separator 3 in the left-right direction. Therefore, the clearance CL1 separated in the front-rear direction, through which the cooling medium flows, is provided at the right end of the tunnel portions 51 and 53. Thus, the cooling medium that has flowed through the cooling flow path PAw is guided to the through-hole 302 via the clearance CL1 at the right end of the tunnel portions 51 and 53 and the communication flow path PA21 between the tunnel portions 51 and 53.

As shown in FIGS. 4A and 4B, the cooling flow path PAw is provided in an area that includes the active area AR1, and provided from the connection area AR3 on the left side of the tunnel portions 52 and 54 to the connection area AR3 on the right side of the tunnel portions 51 and 53. As shown in FIG. 7, in the connection area AR3, multiple rib portions 55 that regulate the flow direction of the cooling medium are provided on both the rear plate 3R and the front plate 3F. The positions of the rib portions 55 of the rear plate 3R in the up-down and left-right directions are the same as the positions of the rib portions 55 of the front plate 3F in the up-down and left-right directions. The multiple rib portions 55 have the same shape when viewed from the front of the separator 3, and their protrusion amounts in the front-rear direction and their widths in the up-down direction are equal to each other.

FIG. 9 is a cross-sectional view along line IX-IX in FIG. 7. As shown in FIG. 9, the rib portions 55 of the rear plate 3R protrude forward from the front surface 3Ra of the rear plate 3R, and the rib portions 55 of the front plate 3F protrude rearward from the rear surface 3Fb of the front plate 3F. That is, the rib portions 55 protrude in the direction opposite to protrusion direction of the bead portions 32, 33, 35 and 36 and the tunnel portions 52 and 54 in FIG. 8, in the front-rear direction. The rib portions 55 have a substantially rectangular cross-section, more specifically, a substantially trapezoidal cross-section.

The front end surfaces of the rib portions 55 of the rear plate 3R and the rear end surfaces of the rib portions 55 of the front plate 3F come into contact with each other, and a flow path of the cooling medium (referred to as a connecting flow path) PA22 is formed between the rib portions 55 and 55 aligned in the up-down direction. At this time, a side wall or a partition of the connecting flow path PA22 is configured by the rib portion 55, and the cooling medium flows along the rib portion 55.

As shown in FIG. 7, in the front view of the separator 3, the rib portions 55 are provided between the tunnel portions 52 and 54 and the tunnel portions 52 and 54 aligned in the up-down direction, above the uppermost tunnel portions 52 and 54, and below the lowermost tunnel portions 52 and 54. These multiple rib portions 55 are arranged parallel to each other and extend in the left-right direction. The lengths of the multiple rib portions 55 in the left-right direction are equal to each other, and their positions in the left-right direction are also equal to each other.

The right ends of the rib portions 55 are located to the left from the left ends of the tunnel portions 52 and 54 by a predetermined distance. The left ends of the rib portions 55 are located to the right from the embossed portions 373 and 374 (FIGS. 4A and 4B) or from the right ends of the gas flow paths PAa and Pac by a predetermined distance. The distance from the right end of the rib portion 55 to the end area AR2 is shorter than the distance from the left end of the rib portion 55 to the active area AR1, and the rib portion 55 is provided closer to the right side (tunnel portion side) within the connection area AR3. The distance from the right end of the rib portion 55 to the end area AR2 and the distance from the left end of the rib portion 55 to the active area AR1 may be equal to each other. It is also possible to omit the embossed portions 373 and 374 and provide the rib portions 55 in the entire area in the left-right direction of the connection area AR3.

By providing the rib portion 55 in this way, the connecting flow path PA22 is located on the extension line of the communication flow path PA21 inside the tunnel portions 52 and 54. In other words, the communication flow path AR21 and the connecting flow path AR22 are located on the same straight line with each other. As a result, as shown by the dotted arrow in FIG. 7, the cooling medium that has flowed through the communication flow path PA21 flows through the connecting flow path PA22 without changing its flow direction. Therefore, the flow of the cooling medium in the connection area AR3 is smooth, and the cooling effect by the flow of the cooling medium can be enhanced.

Although detailed illustration is omitted, the rib portions 55 are similarly provided to the right of the tunnel portions 51 and 53. That is, the rib portions 55 to the right of the tunnel portions 51 and 53 and the rib portions 55 to the left of the tunnel portions 52 and 54 are provided symmetrically in the left-right direction with respect to the axial line extending in the up-down direction through the intermediate portion in the left-right direction of the separator 3. Therefore, in the right side of the tunnel portions 51 and 53, the connecting flow path PA22 is provided between the rib portions 55 and 55 adjacent in the up-down direction among the rib portions 55 arranged at equal intervals in the up-down direction. Thus, the cooling medium that has flowed through the cooling flow path PAw is guided to the through-hole 302 via the connecting flow path PA22 and the communication flow path PA21.

As described above, the rear end surface of the rib portion 55 of the front plate 3F and the front end surface of the rib portion 55 of the rear plate 3R come into contact with each other (FIG. 9). This increases the rigidity of the separator 3 in the connection area AR3, and can suppress deflection and deformation of the separator 3. Specifically, it is possible to prevent the separator 3 from bending due to the compressive load F in the front-rear direction during the assembly of the fuel cell stack 100. As a result, the sealing performance at the contact part between the separator 3 and the frame 21 can be ensured.

According to the present embodiment, the following operations and effects are achievable.

(1) The separator 3 according to the present embodiment is included in a fuel cell stack 100 together with a unitized electrode assembly 2 and configured as a fuel cell separator. The unitized electrode assembly 2 is a joint body of an electrolyte membrane 23, an anode electrode 24 and a cathode electrode 25, and the fuel cell stack 100 is configured by alternately stacking the separator 3 and the electrode assembly 2 (FIGS. 1 and 2). The separator 3 has a pair of plates made of metal, which are the front plate 3F and the rear plate 3R joined with each other (FIG. 2). The front plate 3F has a rear surface 3Fb facing the rear plate 3R and a front surface 3Fa on the opposite side of the rear surface 3Fb, and the rear plate 3R has a front surface 3Ra facing the front plate 3F and a rear surface 3Rb on the opposite side of the front surface 3Ra (FIG. 2). Through-holes 305 that form a flow path for supplying the cooling medium and through-holes 302 that form a flow path for discharging the cooling medium are provided in each of the front plate 3F and the rear plate 3R, and a cooling flow path PAw through which the cooling medium flows is formed between the rear surface 3Fb of the front plate 3F and the front surface 3Ra of the rear plate 3R facing each other (FIG. 2). The separator 3 includes an active area (a first area) AR1 facing the membrane electrode assembly 20, an end area (a second area) AR2 around the through-holes 302 and 305, and a connection area (a third area) AR3 between the active area AR1 and the end area AR2 (FIGS. 4A and 4B).

The front plate 3F includes convex portions 309 and concave portions 310 provided in the active area AR1 so as to form a cathode flow path PAc in the space between the membrane electrode assembly 20 and the front surface 3Fa of the front plate 3F, bead portions 35 and 36 provided in the end area AR2 which protrude towards the frame 21 of the unitized electrode assembly 2 to block a communication between the through-holes 302 and 305 and the cathode flow path PAc, tunnel portions 53 and 54 provided crossing the bead portions 35 and 36 which protrude towards the frame 21 to form a communication flow path PA21 which connects the through-holes 302 and 305 and the cooling flow path PAw, and a rib portion 55 provided in the connection area AR3 so as to be continuous to the tunnel portions 53 and 54 to form a connecting flow path PA22, which is part of the cooling flow path PAw (FIGS. 4B, 7 and 8). The rear plate 3R includes convex portions 307 and concave portions 308 provided in the active area AR1 so as to form an anode flow path PAa in the space between the membrane electrode assembly 20 and the rear surface 3Rb of the rear plate 3R, bead portions 32 and 33 provided in the end area AR2 which protrude towards the frame 21 of the unitized electrode assembly 2 to block a communication between the through-holes 302 and 305 and the anode flow path PAa, tunnel portions 51 and 52 provided crossing the bead portions 32 and 33 which protrude towards the frame 21 to form a communication flow path PA21 which connects the through-holes 302 and 305 and the cooling flow path PAw, and a rib portion 55 provided in the connection area AR3 so as to be continuous to the tunnel portions 51 and 52 to form a connecting flow path PA22, which is part of the cooling flow path PAw (FIGS. 4A, 7, and 8).

By providing the rib portion 55 in the separator 3 in this way, the rigidity of the separator 3 is increased, and deflection or deformation of the separator 3 can be suppressed. As a result, the sealing performance at the contact portion between the separator 3 and the frame 21 can be ensured. In contrast, if the front plate 3F and the rear plate 3R are simply configured as flat plates in the connection area AR3, for example, when a compressive load F acts in the front-rear direction, deflection or deformation may occur in the separator 3, and sufficient sealing performance may not be ensured.

(2) The rib portion 55 is provided so that the connecting flow path PA22 extends along the extension line of the communication flow path PA21 (FIG. 7). As a result, the cooling medium that has flowed through the communication flow path PA21 flows smoothly through the connecting flow path PA22 (on the inlet side of the cooling flow path PAw), and the cooling medium that has flowed through the connecting flow path PA22 flows smoothly through the communication flow path PA21 (on the outlet side of the cooling flow path PAw). Therefore, the pressure loss against the flow of the cooling medium is small, and the cooling effect can be enhanced.

(3) The rib portions 55 of the front plate 3F and the rib portions 55 of the rear plate 3R respectively protrude from the rear surface 3Fb and the front surface 3Ra to form the sidewall portions (sidewalls or partitions) of the connecting flow path PA22, and come into contact with each other (FIG. 9). By making the rib portions 55 come into contact with each other in this way, the rigidity of the connection area AR3 of the separator 3 against the compressive load F in the front-rear direction is further increased.

(4) The tunnel portions 51 to 54 are provided so that the communication flow path PA21 extends in a substantially straight line from one end to the other (FIGS. 4A, 4B and 7). As a result, the cooling medium flows smoothly through the communication flow path PA21, and it is possible to efficiently guide the cooling medium from the through-hole 305 to the connection area AR3, and from the connection area AR3 to the through-hole 302.

(5) The rib portion 55 is provided so that the connecting flow path PA22 extends in a substantially straight line continuous to the communication flow path PA21 (FIG. 7). According to this configuration, the cooling medium flows straight from the through-hole 305 to the left end of the right connecting flow path PA22, and from the right end of the left connecting flow path PA22 to the through-hole 302. Therefore, it is possible to minimize the loss in the flow of the cooling medium from the through-hole 305 to the through-hole 302.

(6) The fuel cell stack 100 includes an unitized electrode assembly 2 including a membrane electrode assembly 20, which is a joint body of an electrolyte membrane 23, an anode electrode 24 and a cathode electrode 25, and a plurality of the aforementioned separators 3, which are alternately stacked with multiple unitized electrode assemblies 2 (FIG. 1). In such a fuel cell stack 100, a compressive load F in the front-rear direction is applied during assembly, but by providing the rib portion 55 in the separator 3, the rigidity of the separator 3 is increased, and deflection or deformation of the separator 3 can be suppressed.

The above embodiment can be modified in various forms. Below, some modified examples are described. In the above embodiment, the rib portion 55 is provided in the connection area AR3 of the separator 3 as a second flow path forming part to form the flow path (connecting flow path PA22) of the cooling medium, but it is also possible to provide a concave-convex flow path forming part to form the flow path of the reaction gas. FIG. 10 is a diagram showing an example of the configuration of the rib portion 55 around the through-hole 302 in that case. In FIG. 10, a concave-convex flow path PA23 through which fuel gas flows is formed from the through-hole 301 (FIG. 1) toward the anode flow path PAa. The flow path PA23 passes to the right of the rib portion 55, and the area where the flow path PA23 is provided expands downward. The rib portion 55 is gradually formed longer downwards so as not to interfere with the flow path PA23. Thus, the lengths of the multiple rib portions 55 do not have to be identical to each other. Moreover, regardless of whether the flow path PA23 is provided or not, the lengths of the multiple rib portions 55 can be different from each other.

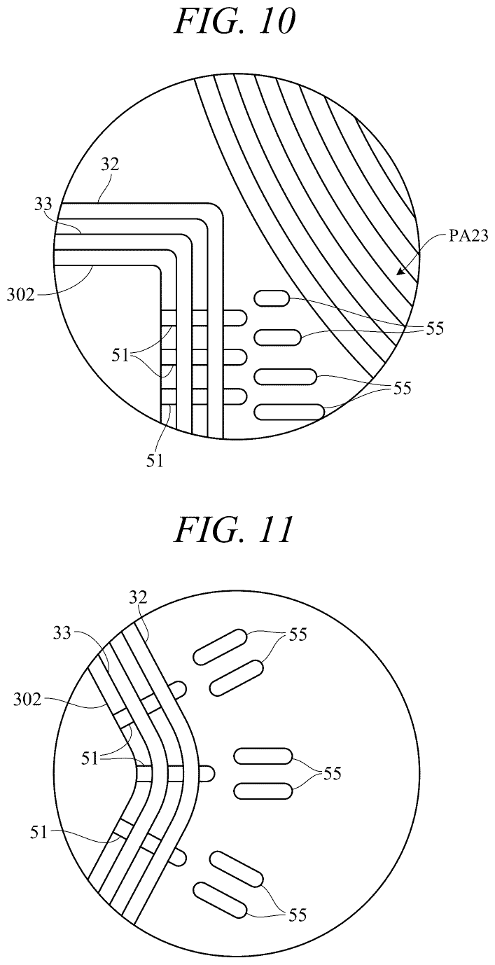

In the above embodiment, the through-holes 301 to 306 of the separator 3 are configured to be substantially rectangular, but the shapes of the through-holes 301 to 306 can be various shapes such as other polygons, circles, and combinations of straight lines and curves. The number and arrangement of the through-holes 301 to 306 are not limited to those described above. In the above embodiment, multiple rib portions 55 are provided parallel to each other, but they do not have to be parallel. FIG. 11 is a diagram showing an example of the rib portion 55 around the through-hole 302 configured in such a manner. In FIG. 11, part of the periphery of the through-hole 302 has a curved shape when viewed from the front, and the tunnel portion 51 and the rib portion 55 extend perpendicularly to this periphery. Therefore, the multiple rib portions 55 are not parallel to each other. Moreover, the multiple rib portions 55 may not be parallel, regardless of whether the periphery of the through-hole 302 is curved or not. The direction in which the rib portion 55 extends may not be perpendicular to the periphery of the through-hole 302. In the above embodiment, the multiple rib portions 55 are provided at equal intervals, but they do not have to be provided at equal intervals.

In the above embodiment, the width of the communication flow path PA21 and the width of the connecting flow path PA22 are kept constant throughout the entire length of the flow paths PA21 and PA22, but they may vary along the length of the flow paths PA21 and PA22. For example, the rib portion 55 may be inclined in the up-down direction when viewed from the front of the separator 3 so that the width of the connecting flow path PA22 on the upstream side of the cooling flow path PAw gradually increases towards the downstream side in the flow direction of the cooling medium. The rib portion 55 may be inclined in the up-down direction when viewed from the front of the separator 3 so that the width of the connecting flow path PA22 on the downstream side of the cooling flow path PAw gradually decreases towards the downstream side in the flow direction of the cooling medium. In the above embodiment, the tunnel portions 51 to 54 extend from one side of the rectangular periphery of the through-holes 302 and 305, but tunnel parts may extend from multiple sides (for example, two intersecting sides). In this case, the directions in which the tunnel parts extend from each side may be different from each other or may be the same.

In the above embodiment, the connecting flow path PA22 is formed in a straight line, but part or all of it may be formed in a curved shape. In the above embodiment, the communication flow path PA21 inside the tunnel portions 51 to 54 and the connecting flow path PA22 on the inside in the left-right direction of the tunnel portions 51 to 54 are communicated through the clearance CL1 between a pair of plates 3F and 3R, but similar to FIGS. 6A and 6B, a through-hole may be opened in plates 3F and 3R to communicate the communication flow path PA21 and the connecting flow path PA22. In the above embodiment, the separator 3 has a pair of rib portions 55 (protrusions) that protrude from the opposing inner surfaces (rear surface 3Fb, front surface 3Ra) of a pair of plates 3F and 3R and contact each other, so as to form a sidewall portion of the connecting flow path PA22 with the pair of rib portions 55, but the pair of rib portions do not need to contact each other, and the configuration of a second flow path forming part is not limited to the above configuration.

In the above embodiment, the active area AR1 of the plates 3F, 3R is configured with a concave-convex shape to form the gas flow paths PAa and PAc between the membrane electrode assembly 20 and the outer surfaces (front surface 3Fa, rear surface 3Rb) of plates 3F and 3R, but the configuration of a first flow path forming part is not limited to the above configuration. In the above embodiment, the bead portions 32, 33, 35 and 36 are protruded towards the unitized electrode assembly 2 (a structure) to block the communication between the through-holes 302 and 305 (communication holes) and the cooling flow path PAw (a cooling medium flow path), but the configuration of a seal part is not limited to the above configuration. In the above embodiment, the connecting flow path PA22 extends along the extension line of the communication flow path PA21, but a connecting flow path may deviate from the extension line of a communication flow path.

In the above embodiment, the unitized electrode assembly 2, which is a structure including the membrane electrode assembly 20 with the electrolyte membrane 23 and electrodes 24 and 25, and the separator 3, are alternately stacked in the front-rear direction to form the cell stacked body 101, but the stacking direction may be other than the front-rear direction (for example, the up-down direction).

The above embodiment can be combined as desired with one or more of the above modifications. The modifications can also be combined with one another.

According to the present invention, it is possible to increase a rigidity of a separator and suppress deflection and deformation of the separator.

Above, while the present invention has been described with reference to the preferred embodiments thereof, it will be understood, by those skilled in the art, that various changes and modifications may be made thereto without departing from the scope of the appended claims.

What is claimed is:

1. A fuel cell separator included in a fuel cell stack, the fuel cell stack being configured by alternately stacking the fuel cell separator and a structure including a membrane electrode assembly, the membrane electrode assembly being a joint body of an electrolyte membrane and an electrode, the fuel cell separator comprising:
a pair of plates made of metal and joined together, the pair of plates including inner surfaces facing with each other and outer surfaces on opposite sides of the inner surfaces and being configured to form a cooling medium flow path through which a cooling medium flows between a pair of the inner surfaces, wherein
communication holes forming a cooling medium supply flow path to supply the cooling medium to the cooling medium flow path and a cooling medium discharge flow path to discharge the cooling medium from the cooling medium flow path are provided in each of the pair of plates,
the fuel cell separator includes a first area facing the membrane electrode assembly, a second area around the communication holes, and a third area between the first area and the second area, and
the each of the pair of plates includes:
a first flow path forming part with an uneven shape provided in the first area to form gas flow paths in spaces between the membrane electrode assembly and the outer surfaces;
a seal part provided in the second area so as to protrude toward the structure to block a communication of the communication holes and the spaces;
a tunnel part provided crossing the seal part so as to protrude toward the structure to form a communication flow path communicating the communication holes and the cooling medium flow path; and
a second flow path forming part with an uneven shape provided in the third area so as to be continuous to the tunnel part to form a connecting flow path included in the cooling medium flow path.

2. The fuel cell separator according to claim 1, wherein
the second flow path forming part is provided so that the connecting flow path extends along an extension line of the communication flow path.

3. The fuel cell separator according to claim 1, wherein
the second flow path forming part includes protrusions protruding from the inner surfaces and abutting each other to form sidewall portions of the connecting flow path.

4. The fuel cell separator according to claim 1, wherein
the tunnel part is provided so that the communication flow path extends in a substantially straight line from one end to another end thereof.

5. The fuel cell separator according to claim 4, wherein
the second flow path forming part is provided so that the connecting flow path extends in the substantially straight line so as to be continuous to the communication flow path.

6. The fuel cell separator according to claim 5, wherein
the tunnel part includes a plurality of tunnel parts provided substantially parallel to each other, and
the second flow path forming part includes a plurality of second flow path forming parts corresponding to the plurality of tunnel parts.

7. The fuel cell separator according to claim 6, wherein
the connecting flow path includes a plurality of connecting flow paths provided substantially parallel to each other, and
the plurality of second flow path forming parts include protrusions protruding from the inner surfaces and extending substantially parallel to each other to form sidewall portions of the plurality of connecting flow paths.

8. The fuel cell separator according to claim 1, wherein
the pair of plates are configured so that a clearance communicating the communication flow path and the connecting flow path is formed between the pair of plates.

9. The fuel cell separator according to claim 1, wherein
the each of the pair of plates includes a plurality of protrusions protruding from each of the inner surfaces toward one direction and another direction between the first flow path forming part and the second flow path forming part.

10. The fuel cell stack, comprising:
a plurality of structures each including the membrane electrode assembly; and
a plurality of fuel cell separators alternately stacking with the plurality of structures, each of the plurality of fuel cell separators being the fuel cell separator according to claim 1.
